(19) United States
(12) Patent Application Publication
(10) Pub. No.: US 2006/0229844 A1
(43) Pub. Date: Oct. 12, 2006

(54) Method for monitoring laboratory samples

(75) Inventor: Annette Becker, Dusseldorf (DE)

Correspondence Address: GUDRUN E. HUCKETT DRAUDT, LONSSTR. 53, WUPPERTAL, 42289, DE

(73) Assignee: UNIVERSITATSKLINIK DUSSELDORF, Dusseldorf (DE)

(21) Appl. No.: 10/906,299

(22) Filed: Feb. 14, 2005

(30) Foreign Application Priority Data
Feb. 14, 2004 (DE) 10 2004 007 298.1

(51) Int. Cl. G06F 17/18

(52) U.S. Cl. 702/179

(57) ABSTRACT

For monitoring samples to be analyzed, the samples are registered in a client data system and a lab order regarding tests to be performed is generated. A data set of each sample is transmitted to a lab system of a commissioned lab and to a sample monitoring system. Samples assigned to the lab are combined to a batch having a specific batch identification code assigned by the client data system. The data sets of the samples of the batch are correlated to the batch identification code. Collection of the batch by a transport service is recorded in the sample monitoring system, and the transport order is correlated to the batch identification code. The lab acknowledges receipt of the batch to the client data system based on batch identification code or sample data sets. The analytical results linked to the sample data sets are transmitted to the client data system.

### BACKGROUND OF THE INVENTION

The invention relates to a method for monitoring samples to be analyzed wherein the samples after having been taken are analyzed at a location that is different from the location of sampling.

The analysis of samples, in particular, of patient samples taken in hospitals, food samples, and environmental and industrial water and soil samples is mostly not carried out on-site, i.e., in the hospitals or industrial facilities, respectively, but in laboratories (labs) that are specialized in analyzing such samples. These labs are generally not located within the same building in which the sample has been taken. The transport of the samples leads inevitably to a delay of the analysis. Moreover, there is the risk that samples are mixed up or even forgotten.

In hospitals, analyses of blood, urine etc. are required in order to diagnose the condition of a patient and in order to begin a concrete treatment based on the analysis. The samples required for the analysis are taken from the patient by the nursing personnel of the hospital unit and filled into sample tubes provided therefor or into other suitable sample containers. Subsequently, the samples are sent to the lab. The sample transport is generally carried out by a separate transport service. In the lab, the required analyses are performed, and for this purpose the samples are correlated with the required analytical devices for determining the requested parameters. After completion of analysis and clearance of the results, the results are transmitted to the client, i.e., to the hospital unit that requested the analysis.

The identification of the samples is conventionally done by a so-called barcode that contains information in regard to the customer, the contents of the sample, the type of analysis, and optionally additional data.

In the above indicated sequence chain there are many sources of error by which the speedy analysis of the samples is impaired. For example, it can happen that samples are left behind or that not enough material is removed. Also, it can happen that identification labels become unreadable or samples are lost during transport to the lab. When the condition of a patient deteriorates, routine samples become emergency samples whose analysis must be carried out immediately. In the sequence cascade that is conventional in practice it is however not easily possible to quickly find samples that have already been taken and to accelerate their analysis. Even when using an electronic requesting method, there is no information in regard to completion of sample taking, completeness, or actual location of the samples. For the requestor of the analysis, generally the physician, it is not possible to determine whether all required samples have been taken correctly and have been sent on their way, where the samples are located currently, and whether they have already been analyzed. Only at the end of a routine day it is possible to determine whether results are possibly still missing. By each individual delay in the course of analysis the treatment of the patient is also delayed; this can cause additional problems.

### SUMMARY OF THE INVENTION

It is an object of the present invention to provide a method for monitoring samples to be analyzed which method has no longer the afore described disadvantages. In particular in connection with hospitals, it is desirable to provide a method that enables monitoring of the samples after taking the samples, preferably already at the point of deciding on performing a lab analysis and inputting the data in a data system. The time between taking the sample and arrival of the sample in the lab (laboratory) should be short and free of logistic delays. Moreover, it is desirable for the client and optionally the already commissioned laboratory to known where the sample is within the conventional sequence chain or to be informed as soon as possible in regard to disruptions in the sequence chain.

In accordance with the present invention, this is achieved in that the method for monitoring samples to be analyzed comprises the following steps:
a) registering the sample in the data system (DS) of the client,
b) generating a lab order based on the data in regard to the analyses/tests to be performed,
c) producing a sample-linked data set in the data system (DS) of the client and transmitting the data set to the laboratory system (LS) of the commissioned lab as well as to the sample monitoring system,
d) combining the samples assigned to the commissioned lab to at least one batch, generating within the data system (DS) of the client a batch identification code specific to the batch, for example, a case number, as well as correlating the data sets of the individual samples of the batch to the batch identification code,
e) i. optionally generating a transport order to a transport service,
   ii. recording the pick-up (collection) of the sample(s) or batch(es) in the sample monitoring system by a transport service and correlating the order with the batch identification code of the batch to be transported,
f) transport of the samples to the commissioned lab,
g) by data transfer to the data system of the client, acknowledgment of arrival of the samples in the commissioned lab by means of the batch identification code and/or the data sets of the individual samples,
h) performing the analysis,
i) by data transfer to the data system (DS) of the client, transmitting the analysis results linked to the data sets, respectively.

The monitoring system according to the invention for lab samples has the advantage that, as the sample is taken and the sample is registered in a data system, a correlation of the sample to lab orders and also a control of sample completeness can be directly performed. At the same time, there is the possibility for optimizing the transport of one sample or several samples and to prepare the sequence of analysis within the lab by early commissioning of the lab. This holds true also for analysis of samples whose urgency is subsequently raised to the level of “emergency”. A permanent verification of the data sets of a sample in the system of the client and in the lab system is therefore possible.

In the context of the present invention, the expression data system encompasses the system into which the data of the sample for registering and monitoring of the sample are input; this can be the lab system or the sample monitoring system itself but also any other electronic requesting system that communicates by means of an interface with the computing system of a central service provider. The data system can be, for example, the order screen of the lab system, a physician's office system, a hospital information system, or the input screen of a sample monitoring system. The sample monitoring system and lab system can be designed as a common data system; they can also be designed as two systems that operate separately from one another but communicate data with one another. In the latter configuration, it is however preferred that the individual systems are linked with one another such that the client can recognize by means of the sample monitoring system if and when the sample has been detected by the lab system and, particularly preferred, when the analysis result is likely to be expected. Also, it is preferred that the status and the location where the sample is located currently can be checked by means of the lab system.

For performing the method according to the invention, the client decides if and in which form the sample is to be taken and which analysis is to be performed. The client in the context of the present invention will be in the case of analyses of patient samples the examining or treating physician in the hospital; in the case of analyzing food samples, the client will be the person who has to make a decision regarding the type and scope of the analysis, and the same holds true for analyses in the context of environmental analyses. The person who is the client in the context of the present invention can also be the person taking the samples and/or the person deciding which analyses are to be performed. Already when making the decision regarding the analysis to be performed, the analysis can be input into the data system according to step a) and a lab order can be placed according to step b).

In step c) a sample-related data set is produced in the data system (DS) of the client and this data set is transmitted together with the correlated order regarding the analysis/analyses to be performed to the lab system (LS) of the commissioned lab and to the sample monitoring system. In one embodiment of the present invention, it is possible to send the order, including type, scope, and urgency of the analysis, to the lab already before the actual sample has been taken. However, this step can also be performed after the sample has been taken. Whether the method steps b) and c) are performed entirely or in partial steps before, after or parallel to taking the sample can depend, for example, on the organizational procedures for ordering.

Sample taking itself is realized as is known in the art. In the case of liquid sample material, the material is filled into a suitable sample container. The term sample used in the context of the present invention is meant to refer to the sample optionally filled into an appropriate sample container. When the sample material is in solid form and is toxicologically innocuous with regard to the environment, it is also possible that the sample is present as piece goods without being filled into a corresponding sample container or that the sample is filled into special sample containers that deviate with regard to size and shape from the usually employed standardized sample containers.

According to the invention, the data of the samples that have been taken are now registered at the latest by a data system if registration has not already been carried out before taking the sample, and a data set is produced preferably in an electronic data system. Preferably, all data correlated with the analysis of the sample, such as client, origin of the sample (patient, water, soil etc.), reason for taking the sample, as well as type and scope of the analyses to be performed and also date and time of taking the sample should be input into the data system. For a speedy execution of the analysis it is advantageous when the data system also contains information in regard to the desired completion of the analyses. Inputting such data has the advantage that when the analysis order according to step b) is sent to the lab, the lab at the same time also receives a message in regard to how fast the analysis is to be performed. Since it may be very complex or cumbersome to provide for each sample the desired deadline at which the analysis is to be completed, it has been found to be suitable to classify the samples with a so-called urgency level. This classification provides the lab with information in regard to how fast or by which deadline the analysis result is to be provided.

In a special configuration of the present invention, the lab acknowledges the order after having received the order. The lab can also send information to the client regarding the form and amount of the sample required for analysis and regarding the requirement for a special treatment of the sample material after taking the sample, for example, adding reagents to the sample material in order to prevent changes of the material between taking the sample and analysis or cooling the material.

For simplifying the further method steps and in order to provide the possibility of following the progress of the sample through electronic media, it was found to be advantageous to provide the samples with a machine-readable identification code, for example, a so-called barcode. Such a sample identification code is generated preferably from the data set that has been input into the data system, for example, into the lab system. In an especially preferred embodiment, the identification code is readable also by such electronic reading devices as they are used by the transport service and by the commissioned lab. In this way, it is possible to electronically determine during the entire runtime of the sample the individual stations and to query the current location or status of the sample.

The sample that has been taken and for which an order has been placed and that is optionally identified by an identification code is prepared in the next step for transport to the lab. Conventionally, the sample identified by the barcode is placed into a sample collector. In this sample collector, according to step d), at least one batch for the commissioned lab is compiled of one or several samples. In the data system (DS) of the client a batch identification code is generated that is specific to the batch; moreover, the correlation of the data sets or, if present, of the identification codes of the individual samples of the batch to the batch identification code takes place. In the batch identification code preferably the data sets of all samples collected in the sample collector are combined. It is preferred that the sample(s) present within the sample collector is/are automatically transported past a reading unit for the identification code in order to detect the samples.

When the sample has been recognized by means of the code and can be correlated to a lab order, the sample can be identified in a subsequent intermediate step in the monitoring system as “prepared for transport to the lab” and is conveyed to a suitable transport container. The transport container is preferably also provided with an electronic readable identifier.

By acquiring the individual data sets of the detected samples in the sample monitoring system, the appropriate transport orders are preferably generated in step e) as a function of the predetermined conditions and rules. The transport orders are linked to the batch identification code of the batch to be transported. The sample can now be transported according to step f) to the lab.

For economic reasons it makes no sense to place an order for the transport service after each acquisition of an individual sample. Currently, It is standard practice that the transport service will visit hospital units, physician offices etc. in regular intervals, once or several times per day, for picking up possibly present samples without being specifically ordered to do so. Preferably, a transport order or a collection order for the transport container is generated and sent out automatically by the data system when certain conditions are fulfilled. Examples of such a so-called collection order or transport order can be situations such as: an emergency order is being placed and the emergency sample(s) is/are registered completely in the data system; the oldest sample has already been registered for xx minutes within the data system, wherein the time xx can be configured, for example, according to collecting location, time of day, and calendar date; the transport container is filled to yy percent wherein yy can be configured in accordance, for example, with the collecting location, time of day, and calendar data; or the collection order is actively initiated by the client because of a special emergency situation. The method enables also a spontaneous pickup by the transport service and making available the corresponding information and the sample status in the sample monitoring system.

In cases in which the sample material must be filled into special sample containers that, because of their size or shape, do not fit into the transport container, said sample is detected by means of a separate reading unit of the sample collector and readied for transport wherein, however, its transport is coordinated preferably together with the pickup and the transport of the conventional transport containers.

In the case that a sample cannot be identified by the data system, a container or a disposal for so-called bad samples is preferably provided. The unreadable sample is placed into this disposal compartment and, preferably, a message is sent to the data system. Preferably, in regular intervals a verification is performed between date and time of sample registration or clearance of the analysis order and detection of the sample in the transport system and, subsequently, in the lab. When arrival of a sample has not been detected in the transport system or the lab after a certain waiting period zz that can be configured as desired, the system sends out an error message or a warning signal. In this way, it is prevented that missing or unreadable samples are forgotten. This signal or error message can be triggered, for example, when the number of these bad samples has surpassed a certain value or when after the last placement of an unreadable sample a certain time period has elapsed. In a preferred embodiment the clients submitting the samples have the possibility of emptying themselves the containers provided for unreadable samples in order to optionally replace the unreadable samples by a new sample or to provide an unreadable sample with a new readable identification code so that the sample can then pass through the proper sequence cascade.

In summarizing the above, the samples that have been placed into the sample collector should be transported to the lab at the latest after a predetermined time T wherein the predetermined time T can also depend on the urgency level.

In a preferred embodiment of the present invention, based on the collection orders sent to the transport service a continuously updated collection list is generated by the monitoring data system. It is also possible that the collection orders are processed by a module that is separate from the monitoring data system, for example, by a transport planning software (data transmission, data transfer). It is preferred that the transport orders and the status of the orders can also be displayed and accordingly monitored by the data system that registers the samples.

For picking up the samples, it is preferred that the commissioned transport service provides an appropriate authorization code as an identification means. Especially preferred, the transport service should be able to pick up the transport container with the corresponding samples only when having the proper authorization code. When providing identification in regard to the transport container and when collecting this container, a corresponding message can be sent simultaneously to the monitoring system; the message indicates that the container has been unlocked for pickup and that the samples contained therein are thus on their way to the lab. Simultaneous with the collection by the transport service, a message in regard to this action is preferably sent to the data system of the client and, when the data system is operated independently of the system of the lab, a message is also sent to the lab.

When arriving at the lab, the employed transport container is identified, preferably also by means of a suitable reading system, and the received samples are registered or, if the orders have already been received, the received samples are compared to the corresponding orders. Preferably, in accordance with step g), the lab will send an acknowledgement to the client and preferably also to the transport service by data transfer to the data system of the client regarding receipt of the samples in the commissioned lab based on the batch identification code and/or identification code of the individual samples. In this way it is possible to immediately identify possibly missing or erroneous samples and to send optionally an error message to the client. The received samples can be sorted by means of conventional sorting devices and in combination with the received orders in regard to the sample material. A device for automatic sorting of sample tubes having a barcode that can be used in connection with the instant invention is disclosed, for example, in German utility model 296 22 078 U1.

In the lab, the analysis is carried out according to the method step h). For this purpose it can be necessary to pre-treat or process the sample in certain ways. Subsequently, the actual analysis or measurement in the appropriate analytical devices is carried out. The analytical results are transmitted, optionally after their separate clearance by the lab director etc., by data transfer to the data system (DS) of the client wherein the results according to step i) are linked to the sample identification code, respectively.

In order to be able to recognize on the sample collector or the transport container whether samples are still waiting to be picked up or when the last sample collection has taken place, it has been found to be suitable to provide the container with a display device that preferably displays the collection cycles or the time of the last collection and of the next automatic collection order; that indicates whether collection orders have been placed, whether unreadable samples are present, including the number of the unreadable samples and the last collection of the unreadable samples; and that displays warning messages and information in regard to the technical device status.

### BRIEF DESCRIPTION OF THE DRAWING

FIG. 1 shows a schematic flowchart illustrating the method according to the invention.

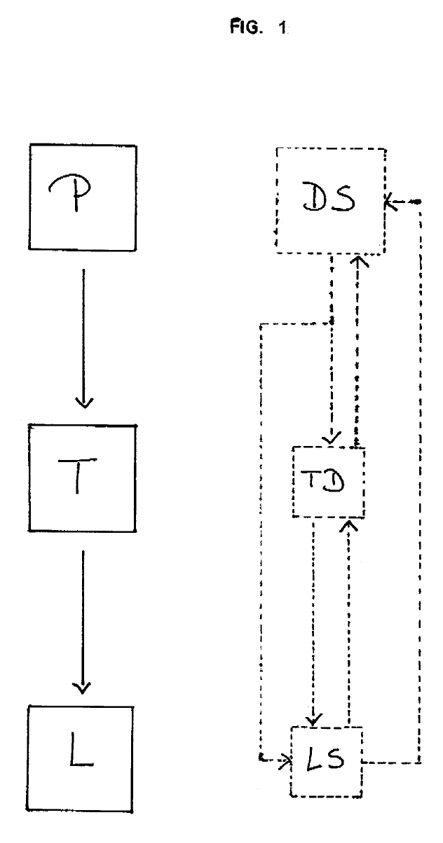

### DESCRIPTION OF THE PREFERRED EMBODIMENTS

After a decision has been made whether and which analysis is to be performed, for example, on a patient, this decision together with all required data is input as a data set into the data system. If the order for taking the sample is not transmitted directly orally or in written form, the order can be sent by the data system to the person that has to take the sample. The order for taking a sample contains, for example, also a temporal parameter regarding a deadline by which point in time this sample must be taken; this temporal parameter can be, for example, a next-day work order for co-workers, for example, in a hospital the order of a physician to the nursing staff.

The data acquisition for the analysis to be performed in the data system triggers an advance notice or order to the lab, preferably through data lines. The lab acknowledges the advance analysis order and sends a return message containing information regarding the required form and required amount of the sample, preferably calculated by the lab system and sent via data lines. Based on this information, the data system of the client produces already the required labels for attachment to the sample tube.

After the sample has been taken, the sample, provided with the required identification, is placed into a sample collector. When the data system already contains all data required for performing the analysis, it is possible to verify for the samples present within the sample collector whether sufficient sample material has been taken. Also, the status of the sample P in regard to whether it has been placed into the sample collector can be checked or polled by means of the data system.

The sample monitoring system PS is operated, for example, in a hospital by the hospital unit personnel; the appropriate input stations should be easily accessible, for example, located in a central position within the unit. In the field of environmental analysis, it is preferred to provide a transportable data system and to enter the corresponding data directly on site.

The transport of the sample P to the lab is realized by a transport container provided for this purpose.

The sample monitoring system or a system separate therefrom for administering the sample transport provides a list of the samples contained therein, i.e., collection orders are generated. The collection order itself is issued based on certain predetermined conditions provided by the data system or the transport system, i.e., when an emergency order is present and/or emergency samples are acquired completely in the data system and are already deposited in the transport container; when the oldest sample has been registered already for a period of time of xx minutes, wherein xx is configured depending on the collection location, time of day, and calendar date; or when the transport container is filled to a predetermined level of yy percent, wherein yy again can be configured based on collecting location, time of day, and calendar date. It is also possible to manually trigger the collection order in individual cases or to document electronically a spontaneous collection. As soon as the collection order has been placed and the samples are on their way to the lab, a message is sent from the transport service TD to the data system of the hospital unit. In the data system DS of the hospital unit it is registered that the sample or the transport container has been collected. The sample status is changed to “sample on its way to the lab”.

In the lab the sample is newly identified, i.e., the transport container as well as the samples themselves are registered and, for example, checked with regard to being intact.

In practice, the transport service operates such that identification as an authorized collector is provided with regard to the sample or transport container. Preferably, the collected transport container is replaced by an empty one.

The arrival of the sample in the lab L is registered by the lab system LS. The received samples are verified relative to the samples that have been announced by the data system DS and the transport service TD. An acknowledgement of the receipt of the samples in the lab L is then sent by the lab system LS to the transport service TD and the data system DS of the client. In the lab, the samples are subsequently prepared and the analysis is performed. The analytical results are then sent after clearance to the data system DS of the client.

While specific embodiments of the invention have been shown and described in detail to illustrate the inventive principles, it will be understood that the invention may be embodied otherwise without departing from such principles.

What is claimed is:

1. A method for monitoring samples to be analyzed, the method comprising the following steps:
a) registering samples in a data system (DS) of a client;
b) generating a lab order based on data regarding analyses/tests to be performed on the samples, respectively;
c) producing a data set for each one of the samples in the data system (DS) of the client and transmitting the data sets to a laboratory system (LS) of a commissioned lab and to a sample monitoring system;
d) compiling at least one batch of at least one of the samples assigned to the commissioned lab, generating within the data system (DS) of the client a batch identification code specific to the at least one batch, and correlating the data set of the at least one of the samples contained in the at least one batch to the batch identification code;
e) recording a collection of the at least one batch by a transport service in the sample monitoring system and correlating a transport order with the batch identification code of the at least one batch to be transported;
f) transporting the at least one batch to the commissioned lab;
g) acknowledging receipt of the at least one batch in the commissioned lab by transferring data to the data system of the client based on at least one of the batch identification code and the data set of the at least one of the samples contained in the at least one batch;
h) performing the analysis,
i) transmitting analytical results linked to the data set of the at least one of the samples, respectively, by data transfer to the data system (DS) of the client.

2. The method according to claim 1, further comprising, between the steps d) and e), the step of generating and placing a transport order with a transport service.

3. The method according to claim 1, further comprising the step of providing the samples each with a sample identification code.

4. The method according to claim 3, further comprising the step of adding an urgency level to the sample identification code.

5. The method according to claim 3, further comprising the step of adding an urgency level to the sample identification code and to the data set of the samples, respectively.

6. The method according to claim 1, further comprising the step of adding an urgency level to the data set of the samples, respectively.

7. The method according to claim 1, further comprising the step of classifying the samples by an urgency level.

8. The method according to claim 1, further comprising the step of collecting the samples in a sample collector, identifying the samples in the sample collector, and initiating transport to the commissioned lab at the latest after a predetermined time xx has elapsed.

9. The method according to claim 8, wherein the predetermined time xx is made dependent on an urgency level assigned to the samples.

10. The method according to claim 1, wherein a current location and a status of the samples are detected by the sample monitoring device.

11. The method according to claim 1, wherein samples that cannot be identified by the data system (DS) are deposited into a disposal.

12. The method according claim 1, further comprising the step of providing a sample collector for collecting the at least one batch for transport with an identification code serving as an indicator or identifier for the transport service.

13. The method according to claim 1, wherein in the step e) a notification is sent to the commissioned lab and to the data system of the client upon collection of the at least one batch by the transport service.

14. The method according to claim 1, wherein the samples are patient samples taken from patients at a hospital.
